(19) United States
(12) Patent Application Publication
(10) Pub. No.: US 2023/0059946 A1
(43) Pub. Date: Feb. 23, 2023

(54) ARTIFICIAL INTELLIGENCE-BASED PROCESS DOCUMENTATION FROM DISPARATE SYSTEM DOCUMENTS

(71) Applicant: INTERNATIONAL BUSINESS MACHINES CORPORATION, Armonk, NY (US)

(72) Inventors: Sujoy Kumar Roy Chowdhury, Kolkata (IN); Anagha M., Palakkad Dt (IN); Swati Anand, Noida (IN); Hiba Nasreen, Malappuram (IN); Roberto Moratore, Haarlem (NL)

(21) Appl. No.: 17/445,256

(22) Filed: Aug. 17, 2021

(51) Int. Cl. G06Q 30/00; G06K 9/00; G06F 40/30

(52) U.S. Cl. CPC G06Q 30/016; G06K 9/00469; G06K 9/00483; G06F 40/30

(57) ABSTRACT

An approach is provided for generating process flow documentation. Headings and subheadings are identified in multiple system documents specifying actions required to be taken in response to service requests, which are specified by process flows. A portion of a system document included in the multiple system documents is mapped to a process block of a process flow included in the process flows. The portion is specified by a heading or subheading in the system document. The mapping is based on a similarity score indicating an amount of similarity between (i) the heading or subheading and (ii) a name of the process block, or based on a matching of the portion of the system document to the process block by a semantic understanding of the portion provided by a machine learning system.

### BACKGROUND

The present invention relates to documenting a process flow using artificial intelligence (AI), and more particularly to automatic chunking and mapping of system documents to individual blocks in a process diagram.

Many of client/customer facing jobs require a manual review of multiple documents (e.g., user manuals) to determine the actions that need to be taken in response to a service request.

### SUMMARY

In one embodiment, the present invention provides a computer system that includes a central processing unit (CPU), a memory coupled to the CPU, and one or more computer readable storage media coupled to the CPU. The one or more computer readable storage media collectively contain instructions that are executed by the CPU via the memory to implement a method of generating process flow documentation. The method includes the computer system identifying headings and subheadings in multiple system documents specifying actions required to be taken in response to service requests, which are specified by process flows. The method further includes based on a similarity score indicating an amount of similarity between (i) a heading or subheading in a system document included in the multiple system documents and (ii) a name of a process block included in a process flow included in the process flows, or based on a matching of a portion of the system document to the process block by a semantic understanding of the portion provided by a machine learning system, the computer system mapping the portion to the process block. The portion is specified by the heading or subheading. The method further includes based on the mapping of the portion to the process block, the computer system generating a documentation of the process flow so that the documentation includes the portion of the system document.

A computer program product and a method corresponding to the above-summarized computer system are also described and claimed herein.

### BRIEF DESCRIPTION OF THE DRAWINGS

FIG. 1 is a block diagram of a system for generating AI-based process flow documentation from a combination of different sections of multiple system documents, in accordance with embodiments of the present invention.

FIGS. 2A-2C depict a flowchart of a process of generating AI-based process flow documentation from a combination of different sections of multiple system documents, in accordance with embodiments of the present invention.

FIG. 3 is an example of a process of generating AI-based process flow documentation from a combination of different sections of multiple system documents, in accordance with embodiments of the present invention.

FIG. 4 is a block diagram of a computer that is included in the system of FIG. 1 and that implements the process of FIGS. 2A-2C, in accordance with embodiments of the present invention.

### DETAILED DESCRIPTION

### Overview

A manual review of multiple system documents (i.e., technical documents such as user manuals) to determine the actions that need to be done in response to a service request is a tedious, time-consuming, and error-prone task.

Embodiments of the present invention address the aforementioned unique challenges of manually reviewing system documents to determine actions that are required by client/customer facing jobs in response to a service request being raised in a process flow. In one embodiment, a documentation system automatically breaks down the aforementioned system documents into simpler pieces (i.e., chunks the system documents) based on the service requests and maps the simpler pieces to different components (i.e., individual process blocks or activities) of the process flow, which are represented in a business process diagram. The automatic chunking of the documents into simpler pieces (i.e., chunks) and the mapping of the pieces of the documents to the components of the process flow allows business analysts and support engineers to select a single relevant document (i.e., a process flow documentation, which is a document relevant to a given service request), which is a combination of different pieces of one or more system documents, which saves a significant amount of time in determining the actions required in response to the service request. In one embodiment, the documentation system uses lexical and semantic matching techniques to map the pieces of the documents to the components of the process flow.

In one embodiment, the documentation system identifies common components across different business processes, creates a database for the identified components, and provides a consistent definition of steps needed to map to a business process. In one embodiment, the documentation system uses natural language processing (NLP) techniques to identify process blocks which are identical to each other.

In one embodiment, the documentation system provides for a delivery of a particular business process from multiple sections from multiple documents. In one embodiment, the documentation system creates a process document for each user-created service request.

In one embodiment, the documentation system reformats the chunks taken from different system documents or sections of documents and combines the reformatted chunks into a common layout, which provides a uniform customer experience for a customer who views documentations of different process flows.

System for Generating AI-Based Process Flow Documentation from System Documents

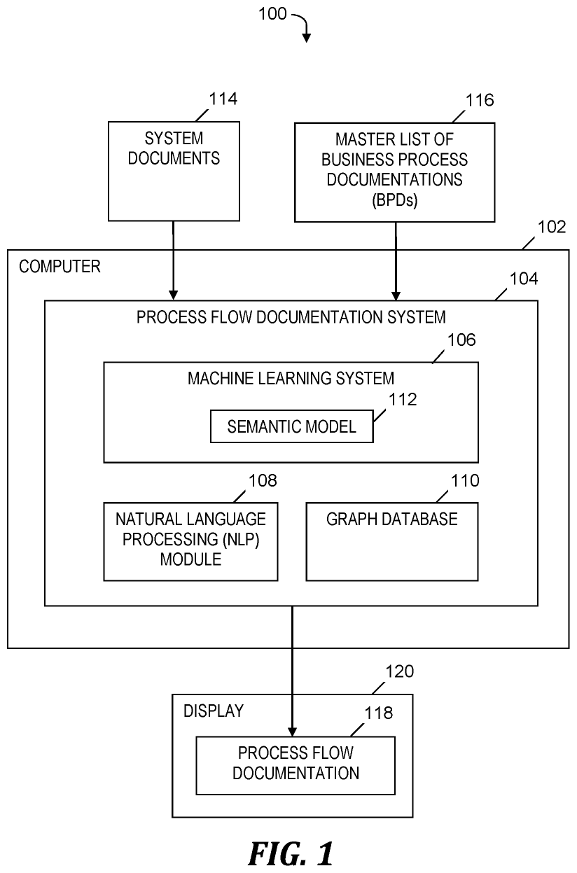

FIG. 1 is a block diagram of a system 100 for generating AI-based process flow documentation from a combination of different sections of multiple system documents, in accordance with embodiments of the present invention. System 100 includes a computer 102 that includes a software-based process flow documentation system 104, which includes a machine learning system 106, a natural language processing (NLP) module 108, and a graph database 110. Machine learning system 106 includes a semantic model 112.

Process flow documentation system 104 receives system documents 114 (e.g., user manuals and user guides) and generates hierarchical JavaScript® Object Notation (JSON) documents (not shown) from the system documents 114. JavaScript is a registered trademark of Oracle America, Inc. located in Redwood Shores, Calif. Process flow documentation system 104 stores the JSON documents in graph database 110. System documents 114 specify actions required to be taken in response to service requests. Sections of system documents 114 are specified by respective nodes in a first set of nodes in the graph database 110. Edges between the nodes that specify the sections of system documents 114 indicate relationships such as hierarchy, similarity score, and the different process blocks of the BPDs in which the sections are used.

Process flow documentation system 104 retrieves business process documentations (BPDs) from a master list 116 of BPDs and stores the BPDs in graph database 110. A BPD specifies a process flow of a service request. Process blocks of the BPDs are specified by respective nodes in a second set of nodes in the graph database 110. The nodes in the second set of nodes (i.e., the nodes specifying the process blocks) are different from the nodes in the aforementioned first set of nodes (i.e., the nodes specifying the sections of the system documents 114). Edges between the nodes that specify the process blocks indicate business process links and hierarchies. An edge between a given first node in the first set of nodes and a given second node in the second set of nodes indicates a relationship of similarities and inclusion (i.e., the section specified by the given first node is matched with the process block specified by the given second node). Graph database 110 allows for a fast retrieval of sections with respect to business processes.

For a given BPD of a process flow for a particular service request, process flow documentation system uses semantic model 112 or NLP module 108 to determine similarity scores between headings in multiple JSON documents and a process block of the given BPD or between sections in multiple JSON documents and the process block. Based on the similarity scores that meet similarity criteria, process flow documentation system 104 maps the corresponding sections of the multiple JSON documents to the process block, and creates a process flow documentation 118 (i.e., a new documentation of the process flow of the service request) by retrieving the mapped sections of the multiple JSON documents from graph database 110 and stitching together the retrieved sections. Process flow documentation system 104 sends the newly created process flow documentation 118 together with a visual representation of the BPD to a display 120 for online viewing by an end user (e.g., a service agent or a business process manager) via a portal. Process flow documentation system 104 generates the aforementioned visual representation of the BPD by using information in the graph database 110.

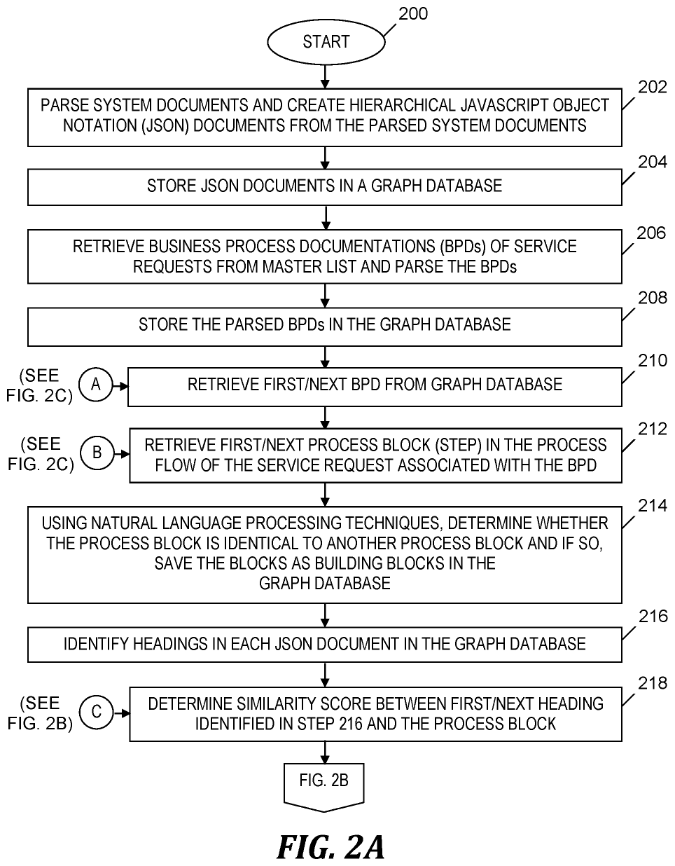

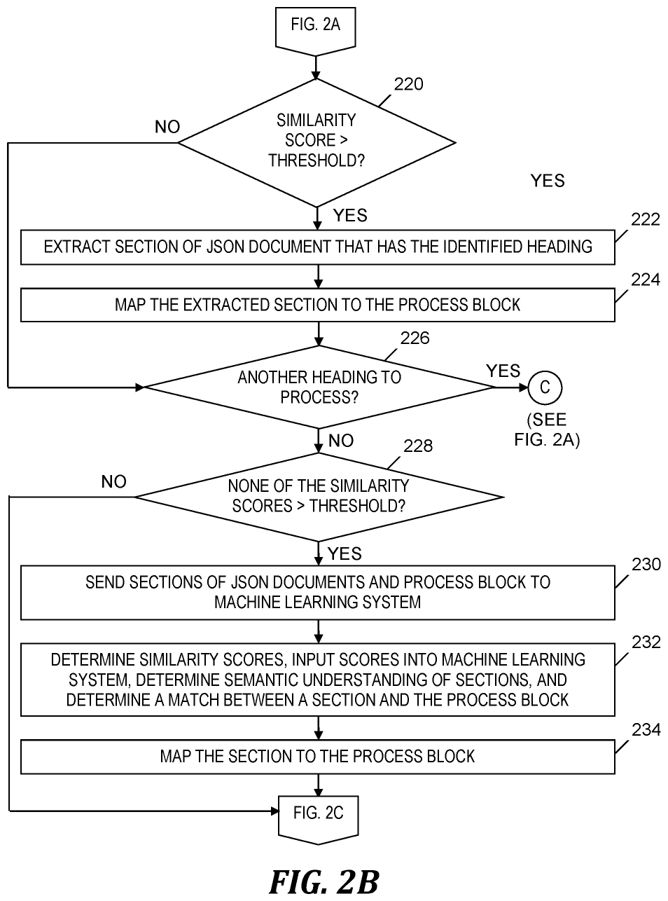

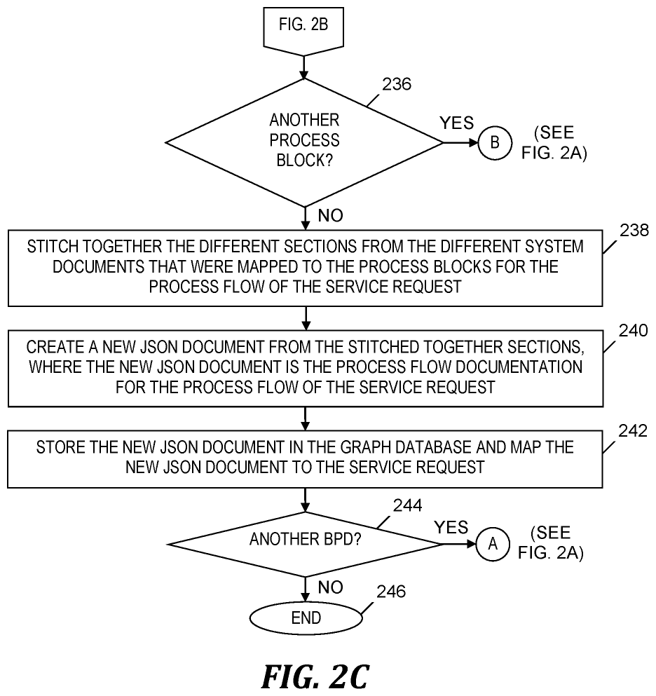

The functionality of the components shown in FIG. 1 is described in more detail in the discussion of FIGS. 2A-2C, FIG. 3, and FIG. 4 presented below.

Process for Generating AI-Based Process Flow Documentation from System Documents

FIGS. 2A-2C depict a flowchart of a process of generating AI-based process flow documentation from a combination of different sections of multiple system documents, in accordance with embodiments of the present invention. The process of FIGS. 2A-2C begins at a start node 200 in FIG. 2A. Prior to step 202, process flow documentation system 104 (see FIG. 1) receives system documents 114 (see FIG. 1). In step 202, process flow documentation system 104 (see FIG. 1) parses system documents 114 (see FIG. 1) and creates hierarchical JSON documents from the parsed system documents 114 (see FIG. 1). The hierarchy of the JSON documents is based on the headings and subheadings in the system documents 114 (see FIG. 1). The JSON documents specify respective system documents included in system documents 114 (see FIG. 1). In one embodiment, if an image is found in a given system document, process flow documentation system 104 (see FIG. 1) stores the image as a base64 string in the JSON document.

In step 204, process flow documentation system 104 (see FIG. 1) stores the JSON documents created in step 202 in graph database 110 (see FIG. 1), so that first nodes in the graph database 110 (see FIG. 1) specify sections in the JSON documents and first edges between the first nodes specify (i) hierarchical relationships among the first nodes, (ii) similarity scores between the first nodes and process blocks of process flows specifying service requests, and (iii) associations between the sections and respective process blocks.

After the prerequisite steps of 202 and 204 are performed, the process of FIGS. 2A-2C starts a pipeline at step 206 to find the maximal matching section for each process block in the process flow of a given BPD.

In step 206, process flow documentation system 104 (see FIG. 1) receives BPDs of service requests by retrieving BPDs of service requests from master list 116 (see FIG. 1). Step 206 also includes process flow documentation system 104 (see FIG. 1) parsing the retrieved BPDs by using an exported Extensible Markup Language (XML) file.

In step 208, process flow documentation system 104 (see FIG. 1) stores the parsed BPDs in graph database 110 (see FIG. 1). In one embodiment, the stored BPDs are specified by second nodes in graph database 110 (see FIG. 1), which are different from the aforementioned first nodes that specify JSON document sections. Edges in graph database 110 (see FIG. 1) between the second nodes specify business process links and hierarchies. Edges between nodes for a BPD and nodes for sections in JSON documents specify relationships of similarities and inclusions or matches of a JSON document section with a section in the BPD.

In the first performance of step 210, process flow documentation system 104 (see FIG. 1) retrieves a first BPD of a first service request from the BPDs stored in graph database 110 (see FIG. 1). In subsequent performances of step 210 via a loop in the process of FIGS. 2A-2C described below, process flow documentation system 104 (see FIG. 1) retrieves a next BPD of a next service request from the BPDs stored in graph database 110 (see FIG. 1).

In a first performance of step 212, process flow documentation system 104 (see FIG. 1) retrieves a first process block (i.e., step) from graph database 110 (see FIG. 1), where the first process block is in the process flow of the service request associated with the BPD retrieved in the most recent performance of step 210. In subsequent performances of step 212 via a loop in the process of FIGS. 2A-2C described below, process flow documentation system 104 (see FIG. 1) retrieves a next process block from graph database 110 (see FIG. 1), where the next process block is in the process flow of the service request associated with the BPD retrieved in the most recent performance of step 210.

In step 214, process flow documentation system 104 (see FIG. 1) determines whether the process block retrieved in the most recent performance of step 212 is identical to another process block by using NLP techniques provided by NLP module 108 (see FIG. 1). If process flow documentation system 104 (see FIG. 1) determines that the process block is identical to another process block, then process flow documentation system 104 (see FIG. 1) saves the identical process blocks in graph database 110 (see FIG. 1) as a building block. Alternatively, process flow documentation system 104 (see FIG. 1) saves the building block in a building block database, which is not shown in FIG. 1. Although not shown in FIGS. 2A-2C, if process flow documentation system 104 (see FIG. 1) determines that the process block is a previously identified building block as indicated in graph database 110 (see FIG. 1) (or as indicated in a building block database), then process flow documentation system 104 (see FIG. 1) extracts from the graph database 110 (see FIG. 1) (or building block database) the section associated with the previously identified building block and maps the section to the process block. By identifying building blocks and mapping sections to building blocks, the process flow documentation system 104 (see FIG. 1) can subsequently change the technical documentation for a particular process block and the change is automatically included in all of the different process flows that include the process block, thereby avoiding the need to make other versions of the process blocks, which saves time and space.

In step 216, process flow documentation system 104 (see FIG. 1) identifies headings and subheadings in each JSON document stored in graph database 110 (see FIG. 1).

In a first performance of step 218, process flow documentation system 104 (see FIG. 1) determines a similarity score indicating an amount of similarity between a first heading or subheading identified in step 216 and a name of the process block retrieved in the most recent performance of step 212. In subsequent performances of step 218 via a loop in the process of FIGS. 2A-2C described below, process flow documentation system 104 (see FIG. 1) determines a similarity score between a next heading or subheading identified in step 216 and a name of the process block retrieved in the most recent performance of step 212. In one embodiment, the similarity score determined in step 218 indicates a similarity between the service request and a heading or subheading included in the headings and subheadings identified in step 216. In one embodiment, process flow documentation system 104 (see FIG. 1) uses a Cosine or Euclidean-based distance calculation to determine the similarity score in step 218.

The process of FIGS. 2A-2C continues with step 220 in FIG. 2B. In step 220, process flow documentation system 104 (see FIG. 1) determines whether the similarity score determined in step 218 is greater than a predetermined threshold score, which is also referred to herein as a threshold value. If process flow documentation system 104 (see FIG. 1) determines that the similarity score is greater than the threshold score, then the Yes branch of step 220 is followed and step 222 is performed.

In step 222, process flow documentation system 104 (see FIG. 1) parses the JSON document specified by the heading or subheading identified in step 216 and extracts a section of the JSON document used in the determination of the similarity score in step 218. In one embodiment, process flow documentation system 104 (see FIG. 1) extracts from the JSON document a dictionary structure whose heading matches the heading or subheading associated with the similarity score determined in step 218. The extraction of the dictionary structure also includes extracting the subheading(s) associated with the heading.

In step 224, process flow documentation system 104 (see FIG. 1) maps the section extracted in step 222 to the process block retrieved in the most recent performance of step 212.

In one embodiment, process flow documentation system 104 (see FIG. 1) represents the mapping in step 224 by an edge in graph database 110 (see FIG. 1) that interconnects different types of nodes (i.e., a first node specifying a section of a JSON document and a second node specifying a process block of a service request).

In one embodiment, multiple performances of step 222 via a loop that starts at step 220 includes process flow documentation system 104 (see FIG. 1) automatically chunking multiple portions (i.e., sections) of multiple system documents included in system documents 114 (see FIG. 1) based on headings and subheadings in the multiple system documents. Furthermore, multiple performances of step 224 via the loop that starts at step 220 includes process flow documentation system 104 (see FIG. 1) automatically mapping the chunked multiple portions of the multiple system documents to process blocks of the BPDs. In one embodiment, process flow documentation system 104 (see FIG. 1) includes (i) reformatting the chunked portions of the multiple system documents and (ii) combining the reformatted chunked portions into a common layout that provides a uniform experience for a customer who views process flow documentation 118 (see FIG. 1) and documentation of other process flows.

Returning to step 220, if process flow documentation system 104 (see FIG. 1) determines that the similarity score is not greater than the threshold score, then the No branch of step 220 is followed and step 226 is performed.

In step 226 following step 224 or the No branch of step 226, process flow documentation system 104 (see FIG. 1) determines whether there is another heading or subheading in the identified headings and subheadings in step 216 that needs to be processed with a determination of a similarity score. If process flow documentation system 104 (see FIG. 1) determines in step 226 that there is another heading or subheading to be processed, then the Yes branch of step 226 is followed and the process of FIGS. 2A-2C loops back to step 218 in FIG. 2A to process the next heading or subheading that was identified in step 216.

If process flow documentation system 104 (see FIG. 1) determines in step 226 that there is not another heading or subheading to process, then the No branch of step 226 is followed and step 228 is performed.

In step 228, process flow documentation system 104 (see FIG. 1) determines whether none of the similarity scores determined in the performance(s) of step 218 are greater than the threshold score. If process flow documentation system 104 (see FIG. 1) determines that none of the similarity scores are greater than the threshold score, then the Yes branch of step 228 is followed and step 230 is performed.

In step 230, process flow documentation system 104 (see FIG. 1) sends sections of the JSON documents in graph database 110 (see FIG. 1) and the process block being currently processed to the semantic model 112 (see FIG. 1) in machine learning system 106 (see FIG. 1).

In one embodiment, machine learning system 106 (see FIG. 1) creates the semantic model 112 (see FIG. 1) by performing the following steps:

1. Create a dataset from the JSON document in which each line has the form: “category label, paragraph belonging to the category, a paragraph that does not belong to the category”

2. Given two sentences, classify the two sentences as entailing, contradicting, or being neutral to each other. For the classification, the machine learning system 106 (see FIG. 1) sends the two sentences to a transformer model to generate fixed-sized sentence embeddings, and are subsequently sent to a Softmax classifier, which derives the final label of entail, contradict, or neutral.

3. Train and save the semantic model 112 (see FIG. 1).

In step 232, process flow documentation system 104 (see FIG. 1) determines similarity scores between the sections sent in step 230 and the process block being currently processed and inputs the similarity scores into the machine learning system, which provides a semantic understanding of the sections. Based in part on the inputted similarity scores and the semantic understanding, the machine learning system determines a match between a section of a JSON document and the process block.

In step 234, process flow documentation system 104 (see FIG. 1) maps the matched section to the process block being currently processed. The mapping in step 234 is based on the semantic understanding of the sections, where the semantic understanding is provided by machine learning system 106 (see FIG. 1) using semantic model 112 (see FIG. 1) and the Bidirectional Encoder Representations from Transformers machine learning technique.

In one embodiment, process flow documentation system 104 (see FIG. 1) represents the mapping in step 234 by an edge in graph database 110 (see FIG. 1) that interconnects different types of nodes (i.e., a first node specifying a section of a JSON document and a second node specifying a process block of a service request).

Returning to step 228, if process flow documentation system 104 (see FIG. 1) determines that at least one of the similarity scores was determined to be greater than the threshold score, then the No branch of step 228 is followed.

Following step 234 and following the No branch of step 228, the process of FIGS. 2A-2C continues with step 236 in FIG. 2C.

In step 236, process flow documentation system 104 (see FIG. 1) determines whether there is another process block in the BPD that has not yet been processed in the loop that begins at step 212 in FIG. 2A. If process flow documentation system 104 (see FIG. 1) determines that there is another process block that has not yet been processed, then the Yes branch of step 236 is followed and the process of FIGS. 2A-2C loops back to step 212 in FIG. 2A, with the next process block in the process flow of the service request associated with BPD being processed.

If process flow documentation system 104 (see FIG. 1) determines that there is not another process block in the BPD that has not yet been processed, then the No branch of step 236 is followed and step 238 is performed.

In step 238, process flow documentation system 104 (see FIG. 1) stitches together the sections that were mapped to the process blocks for the process flow of the service request associated with the BPD being currently processed in the process of FIGS. 2A-2C. In one embodiment, the sections stitched together in step 238 include different sections from different system documents included in system documents 114 (see FIG. 1).

In step 240, based on the mapping performed in step 224 or step 234, process flow documentation system 104 (see FIG. 1) creates a new JSON document from the sections stitched together in step 238. The new JSON document is the process flow documentation 118 (see FIG. 1) of the aforementioned process flow of the service request. In one embodiment, the creation of the new JSON document in step 240 includes using sections of different system documents included in system documents 114 (see FIG. 1), where the sections are included in multiple portions that are chunked and mapped in steps 222 and 224, respectively.

In step 242, process flow documentation system 104 (see FIG. 1) stores the new JSON document (i.e., process flow documentation 118 in FIG. 1) in graph database 110 (see FIG. 1) and maps the new JSON document to the service request. In one embodiment, after step 242, process flow documentation system 104 (see FIG. 1) sends the new JSON document to another computer system which displays the new JSON document on display 120 (see FIG. 1) for viewing by an end user.

In step 244, process flow documentation system 104 (see FIG. 1) determines whether there is another BPD that has not yet been processed in the loop that begins at step 210 in FIG. 2A. If process flow documentation system 104 (see FIG. 1) determines that there is another BPD that has not yet been processed, then the Yes branch of step 244 is followed and the process of FIGS. 2A-2C loops back to step 210 in FIG. 2A, with the next BPD being processed.

If process flow documentation system 104 (see FIG. 1) determines in step 244 that there is not another BPD to be processed, then the No branch of step 244 is followed and the process of FIGS. 2A-2C ends at an end node 246.

In one embodiment, the process of FIGS. 2A-2C includes (i) identifying common components across different process flows of different service requests and (ii) based on the identified common components, mapping a consistent definition of steps to the different process flows.

### EXAMPLE

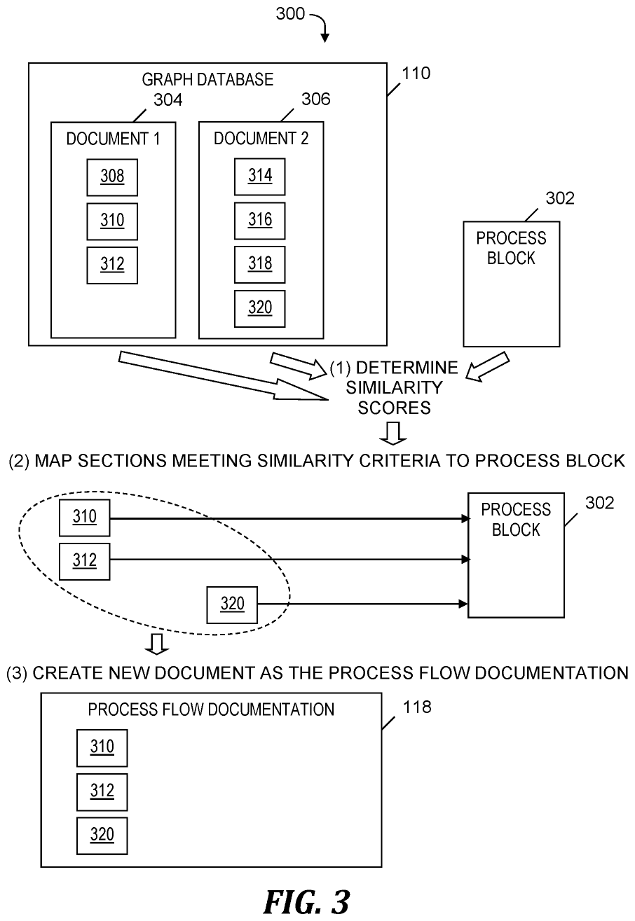

FIG. 3 is an example 300 of a process of generating AI-based process flow documentation from a combination of different parts of multiple system documents, in accordance with embodiments of the present invention. JSON documents 304 and 306 specify respective user guides and are stored in graph database 110. JSON document 304 includes sections 308, 310, and 312. JSON document 306 includes sections 314, 316, 318, and 320. Process block 302 is a process block in a process flow of a service request associated with a BPD.

In step (1) in example 300, process flow documentation system 104 (see FIG. 1) determines similarity scores between each of sections 308, 310, 312, 314, 316, 318, and 320 and the process block 302. Step (1) is comprised of multiple performances of step 218 in FIG. 2A. In step 220 (see FIG. 2B), process flow documentation system 104 (see FIG. 1) determines that the similarity scores for sections 310, 312, and 320 exceed the predetermined threshold score. Based on the similarity scores for sections 310, 312, and 320 exceeding the threshold score, process flow documentation system 104 (see FIG. 1) in step (2) maps sections 310, 312, and 320 to process block 302. Step (2) is included in step 224 (see FIG. 2B).

In step (3), process flow documentation system 104 (see FIG. 1) creates a new JSON document as the process flow documentation 118 for the process flow of the service request. In example 300, process flow documentation 118 includes sections 310, 312, and 320, which are different sections from different user guides. Step (3) is included in step 240 in FIG. 2C.

### Computer System

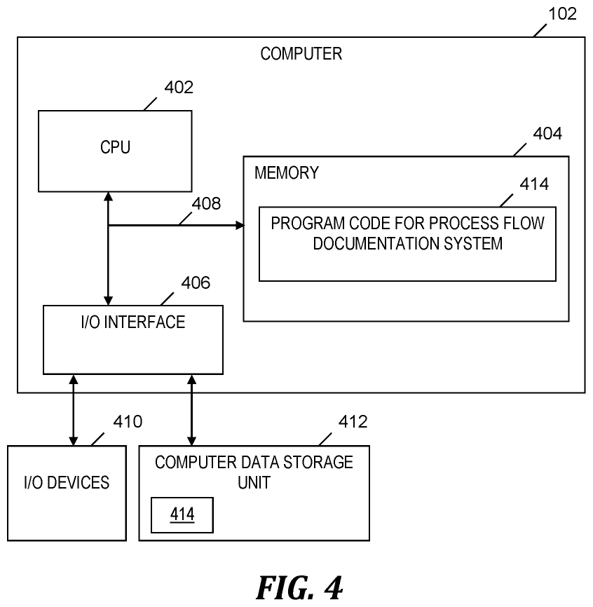

FIG. 4 is a block diagram of a computer that is included in the system of FIG. 1 and that implements the process of FIGS. 2A-2B, in accordance with embodiments of the present invention. Computer 102 is a computer system that generally includes a central processing unit (CPU) 402, a memory 404, an input/output (I/O) interface 406, and a bus 408. Further, computer 102 is coupled to I/O devices 410 and a computer data storage unit 412. CPU 402 performs computation and control functions of computer 102, including executing instructions included in program code 414 for process flow documentation system 104 (see FIG. 1) to perform a method of generating AI-based process flow documentation from a combination of different sections of multiple system documents, where the instructions are executed by CPU 402 via memory 404. CPU 402 may include a single processing unit or processor or be distributed across one or more processing units or one or more processors in one or more locations (e.g., on a client and server).

Memory 404 includes a known computer readable storage medium, which is described below. In one embodiment, cache memory elements of memory 404 provide temporary storage of at least some program code (e.g., program code 414) in order to reduce the number of times code must be retrieved from bulk storage while instructions of the program code are executed. Moreover, similar to CPU 402, memory 404 may reside at a single physical location, including one or more types of data storage, or be distributed across a plurality of physical systems or a plurality of computer readable storage media in various forms. Further, memory 404 can include data distributed across, for example, a local area network (LAN) or a wide area network (WAN).

I/O interface 406 includes any system for exchanging information to or from an external source. I/O devices 410 include any known type of external device, including a display, keyboard, etc. Bus 408 provides a communication link between each of the components in computer 102, and may include any type of transmission link, including electrical, optical, wireless, etc.

I/O interface 406 also allows computer 102 to store information (e.g., data or program instructions such as program code 414) on and retrieve the information from computer data storage unit 412 or another computer data storage unit (not shown). Computer data storage unit 412 includes one or more known computer readable storage media, where a computer readable storage medium is described below. In one embodiment, computer data storage unit 412 is a non-volatile data storage device, such as, for example, a solid-state drive (SSD), a network-attached storage (NAS) array, a storage area network (SAN) array, a magnetic disk drive (i.e., hard disk drive), or an optical disc drive (e.g., a CD-ROM drive which receives a CD-ROM disk or a DVD drive which receives a DVD disc).

Memory 404 and/or storage unit 412 may store computer program code 414 that includes instructions that are executed by CPU 402 via memory 404 to generate AI-based process flow documentation from a combination of different sections of multiple system documents. Although FIG. 4 depicts memory 404 as including program code, the present invention contemplates embodiments in which memory 404 does not include all of code 414 simultaneously, but instead at one time includes only a portion of code 414.

Further, memory 404 may include an operating system (not shown) and may include other systems not shown in FIG. 4.

As will be appreciated by one skilled in the art, in a first embodiment, the present invention may be a method; in a second embodiment, the present invention may be a system; and in a third embodiment, the present invention may be a computer program product.

Any of the components of an embodiment of the present invention can be deployed, managed, serviced, etc. by a service provider that offers to deploy or integrate computing infrastructure with respect to generating AI-based process flow documentation from a combination of different sections of multiple system documents. Thus, an embodiment of the present invention discloses a process for supporting computer infrastructure, where the process includes providing at least one support service for at least one of integrating, hosting, maintaining and deploying computer-readable code (e.g., program code 414) in a computer system (e.g., computer 102) including one or more processors (e.g., CPU 402), wherein the processor(s) carry out instructions contained in the code causing the computer system to generate AI-based process flow documentation from a combination of different sections of multiple system documents. Another embodiment discloses a process for supporting computer infrastructure, where the process includes integrating computer-readable program code into a computer system including a processor. The step of integrating includes storing the program code in a computer-readable storage device of the computer system through use of the processor. The program code, upon being executed by the processor, implements a method of generating AI-based process flow documentation from a combination of different sections of multiple system documents.

While it is understood that program code 414 for generating AI-based process flow documentation from a combination of different sections of multiple system documents may be deployed by manually loading directly in client, server and proxy computers (not shown) via loading a computer-readable storage medium (e.g., computer data storage unit 412), program code 414 may also be automatically or semi-automatically deployed into computer 102 by sending program code 414 to a central server or a group of central servers. Program code 414 is then downloaded into client computers (e.g., computer 102) that will execute program code 414. Alternatively, program code 414 is sent directly to the client computer via e-mail. Program code 414 is then either detached to a directory on the client computer or loaded into a directory on the client computer by a button on the e-mail that executes a program that detaches program code 414 into a directory. Another alternative is to send program code 414 directly to a directory on the client computer hard drive. In a case in which there are proxy servers, the process selects the proxy server code, determines on which computers to place the proxy servers' code, transmits the proxy server code, and then installs the proxy server code on the proxy computer. Program code 414 is transmitted to the proxy server and then it is stored on the proxy server.

Another embodiment of the invention provides a method that performs the process steps on a subscription, advertising and/or fee basis. That is, a service provider can offer to create, maintain, support, etc. a process of generating AI-based process flow documentation from a combination of different sections of multiple system documents. In this case, the service provider can create, maintain, support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The present invention may be a system, a method, and/or a computer program product at any possible technical detail level of integration. The computer program product may include a computer readable storage medium (or media) (i.e., memory 404 and computer data storage unit 412) having computer readable program instructions 414 thereon for causing a processor (e.g., CPU 402) to carry out aspects of the present invention.

The computer readable storage medium can be a tangible device that can retain and store instructions (e.g., program code 414) for use by an instruction execution device (e.g., computer 102). The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions (e.g., program code 414) described herein can be downloaded to respective computing/processing devices (e.g., computer 102) from a computer readable storage medium or to an external computer or external storage device (e.g., computer data storage unit 412) via a network (not shown), for example, the Internet, a local area network, a wide area network and/or a wireless network. The network may comprise copper transmission cables, optical transmission fibers, wireless transmission, routers, firewalls, switches, gateway computers and/or edge servers. A network adapter card (not shown) or network interface (not shown) in each computing/processing device receives computer readable program instructions from the network and forwards the computer readable program instructions for storage in a computer readable storage medium within the respective computing/processing device.

Computer readable program instructions (e.g., program code 414) for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations (e.g., FIGS. 2A-2C) and/or block diagrams (e.g., FIG. 1 and FIG. 4) of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions (e.g., program code 414).

These computer readable program instructions may be provided to a processor (e.g., CPU 402) of a general purpose computer, special purpose computer, or other programmable data processing apparatus (e.g., computer 102) to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium (e.g., computer data storage unit 412) that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions (e.g., program code 414) may also be loaded onto a computer (e.g. computer 102), other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A computer system comprising:
a central processing unit (CPU);
a memory coupled to the CPU; and
one or more computer readable storage media coupled to the CPU, the one or more computer readable storage media collectively containing instructions that are executed by the CPU via the memory to implement a method of generating process flow documentation, the method comprising:
the computer system identifying headings and subheadings in multiple system documents specifying actions required to be taken in response to service requests, which are specified by process flows;
based on a similarity score indicating an amount of similarity between (i) a heading or subheading in a system document included in the multiple system documents and (ii) a name of a process block included in a process flow included in the process flows, or based on a matching of a portion of the system document to the process block by a semantic understanding of the portion provided by a machine learning system, the computer system mapping the portion to the process block, the portion being specified by the heading or subheading; and
based on the mapping of the portion to the process block, the computer system generating a documentation of the process flow so that the documentation includes the portion of the system document.

2. The computer system of claim 1, wherein the method further comprises:
the computer system determining a Euclidean distance-based similarity score indicating a similarity between (i) the heading or subheading and (ii) the name of the process block;
the computer system determining that the Euclidean distance-based similarity score is greater than a threshold value; and
in response to the determining that the Euclidean distance-based similarity score is greater than the threshold value, the computer system parsing a JSON document that includes the heading or subheading and the computer system extracting from the JSON document the portion of the system document that is specified by the heading or subheading.

3. The computer system of claim 1, wherein the method further comprises:
the computer system determining Euclidean distance-based similarity scores indicating similarities between (i) the identified headings and subheadings and (ii) the name of the process block;
the computer system determining that none of the Euclidean distance-based similarity scores is greater than a threshold value; and
in response to the determining that none of the Euclidean distance-based similarity scores is greater than the threshold value, the computer system sending (i) sections of JSON documents that include the identified headings and subheadings and (ii) the process block to the machine learning system, the computer system determining other similarity scores between the sections and the process block, the computer system inputting the other similarity scores into the machine learning system, and based on the inputted other similarity scores and using the machine learning system to provide a semantic understanding of the sections, the computer system mapping a section included in the sections to the process block.

4. The computer system of claim 1, wherein the method further comprises:
the computer system identifying common components across different process flows of different service requests; and
based on the identified common components, the computer system mapping a consistent definition of steps to the different process flows.

5. The computer system of claim 1, wherein the method further comprises:
the computer system reformatting portions of the multiple system documents; and
the computer system combining the reformatted portions into a common layout that provides a uniform experience for a customer who is viewing the documentation of the process flow and other documentations of other process flows.

6. The computer system of claim 1, wherein the method further comprises:
the computer system extracting different portions from the multiple system documents;
the computer system stitching together the different portions, wherein the generating the documentation of the process flow includes using the different portions that are stitched together; and
the computer system storing the documentation of the process flow in a graph database in which the documentation of the process flow is mapped to a service request specified by the process flow.

7. The computer system of claim 1, wherein the method further comprises:
the computer system creating JSON structures by parsing the multiple system documents;
the computer system storing the JSON structures in a graph database so that sections in the multiple system documents are respective nodes in the graph database and edges between the nodes in the graph database specify (i) hierarchical relationships among the sections, (ii) similarity scores indicating respective amounts of similarity between the sections and process blocks specifying service requests, and (iii) associations between the sections and the process blocks; and
the computer system retrieving the stored JSON structures from the graph database, wherein the identifying the headings and subheadings includes identifying the headings and subheadings in the stored JSON structures.

8. A computer program product for generating process flow documentation, the computer program product comprising:
one or more computer readable storage media having computer readable program code collectively stored on the one or more computer readable storage media, the computer readable program code being executed by a central processing unit (CPU) of a computer system to cause the computer system to perform a method comprising:
the computer system identifying headings and subheadings in multiple system documents specifying actions required to be taken in response to service requests, which are specified by process flows;
based on a similarity score indicating an amount of similarity between (i) a heading or subheading in a system document included in the multiple system documents and (ii) a name of a process block included in a process flow included in the process flows, or based on a matching of a portion of the system document to the process block by a semantic understanding of the portion provided by a machine learning system, the computer system mapping the portion to the process block, the portion being specified by the heading or subheading; and
based on the mapping of the portion to the process block, the computer system generating a documentation of the process flow so that the documentation includes the portion of the system document.

9. The computer program product of claim 8, wherein the method further comprises:
the computer system determining a Euclidean distance-based similarity score indicating a similarity between (i) the heading or subheading and (ii) the name of the process block;
the computer system determining that the Euclidean distance-based similarity score is greater than a threshold value; and
in response to the determining that the Euclidean distance-based similarity score is greater than the threshold value, the computer system parsing a JSON document that includes the heading or subheading and the computer system extracting from the JSON document the portion of the system document that is specified by the heading or subheading.

10. The computer program product of claim 8, wherein the method further comprises:
the computer system determining Euclidean distance-based similarity scores indicating similarities between (i) the identified headings and subheadings and (ii) the name of the process block;
the computer system determining that none of the Euclidean distance-based similarity scores is greater than a threshold value; and
in response to the determining that none of the Euclidean distance-based similarity scores is greater than the threshold value, the computer system sending (i) sections of JSON documents that include the identified headings and subheadings and (ii) the process block to the machine learning system, the computer system determining other similarity scores between the sections and the process block, the computer system inputting the other similarity scores into the machine learning system, and based on the inputted other similarity scores and using the machine learning system to provide a semantic understanding of the sections, the computer system mapping a section included in the sections to the process block.

11. The computer program product of claim 8, wherein the method further comprises:
the computer system identifying common components across different process flows of different service requests; and
based on the identified common components, the computer system mapping a consistent definition of steps to the different process flows.

12. The computer program product of claim 8, wherein the method further comprises:
the computer system reformatting portions of the multiple system documents; and
the computer system combining the reformatted portions into a common layout that provides a uniform experience for a customer who is viewing the documentation of the process flow and other documentations of other process flows.

13. The computer program product of claim 8, wherein the method further comprises:
the computer system extracting different portions from the multiple system documents;
the computer system stitching together the different portions, wherein the generating the documentation of the process flow includes using the different portions that are stitched together; and
the computer system storing the documentation of the process flow in a graph database in which the documentation of the process flow is mapped to a service request specified by the process flow.

14. The computer program product of claim 8, wherein the method further comprises:
the computer system creating JSON structures by parsing the multiple system documents;
the computer system storing the JSON structures in a graph database so that sections in the multiple system documents are respective nodes in the graph database and edges between the nodes in the graph database specify (i) hierarchical relationships among the sections, (ii) similarity scores indicating respective amounts of similarity between the sections and process blocks specifying service requests, and (iii) associations between the sections and the process blocks; and
the computer system retrieving the stored JSON structures from the graph database, wherein the identifying the headings and subheadings includes identifying the headings and subheadings in the stored JSON structures.

15. A computer-implemented method comprising:
identifying, by one or more processors, headings and subheadings in multiple system documents specifying actions required to be taken in response to service requests, which are specified by process flows;
based on a similarity score indicating an amount of similarity between (i) a heading or subheading in a system document included in the multiple system documents and (ii) a name of a process block included in a process flow included in the process flows, or based on a matching of a portion of the system document to the process block by a semantic understanding of the portion provided by a machine learning system, mapping, by the one or more processors, the portion to the process block, the portion being specified by the heading or subheading; and
based on the mapping of the portion to the process block, generating, by the one or more processors, a documentation of the process flow so that the documentation includes the portion of the system document.

16. The method of claim 15, further comprising:
determining, by the one or more processors, a Euclidean distance-based similarity score indicating a similarity between (i) the heading or subheading and (ii) the name of the process block;
determining, by the one or more processors, that the Euclidean distance-based similarity score is greater than a threshold value; and
in response to the determining that the Euclidean distance-based similarity score is greater than the threshold value, parsing, by the one or more processors, a JSON document that includes the heading or subheading and extracting, by the one or more processors and from the JSON document, the portion of the system document that is specified by the heading or subheading.

17. The method of claim 15, further comprising:
determining, by the one or more processors, Euclidean distance-based similarity scores indicating similarities between (i) the identified headings and subheadings and (ii) the name of the process block;
determining, by the one or more processors, that none of the Euclidean distance-based similarity scores is greater than a threshold value; and
in response to the determining that none of the Euclidean distance-based similarity scores is greater than the threshold value, sending, by the one or more processors, (i) sections of JSON documents that include the identified headings and subheadings and (ii) the process block to the machine learning system, determining, by the one or more processors, other similarity scores between the sections and the process block, inputting, by the one or more processors, the other similarity scores into the machine learning system, and based on the inputted other similarity scores and using the machine learning system to provide a semantic understanding of the sections, mapping, by the one or more processors, a section included in the sections to the process block.

18. The method of claim 15, further comprising:
identifying, by the one or more processors, common components across different process flows of different service requests; and
based on the identified common components, mapping, by the one or more processors, a consistent definition of steps to the different process flows.

19. The method of claim 15, further comprising:
reformatting, by the one or more processors, portions of the multiple system documents; and
combining, by the one or more processors, the reformatted portions into a common layout that provides a uniform experience for a customer who is viewing the documentation of the process flow and other documentations of other process flows.

20. The method of claim 15, further comprising:
extracting, by the one or more processors, different portions from the multiple system documents;
stitching, by the one or more processors, the different portions together, wherein the generating the documentation of the process flow includes using the different portions that are stitched together; and
storing, by the one or more processors, the documentation of the process flow in a graph database in which the documentation of the process flow is mapped to a service request specified by the process flow.
